(19) United States
(12) Patent Application Publication
(10) Pub. No.: US 2016/0343038 A1
(43) Pub. Date: Nov. 24, 2016

(54) ADVERTISEMENT PRICE DISCOUNTING

(71) Applicant: GOOGLE INC., Mountain View, CA (US)

(72) Inventors: Benjamin Sprecher, Waltham, MA (US); Alexander Rosenschein Vogenthaler, Denver, CO (US); Paul Dexter Gormley, Palo Alto, CA (US); Dong Min Kim, San Jose, CA (US); John Robert Mentgen, San Carlos, CA (US)

(21) Appl. No.: 15/230,362

(22) Filed: Aug. 5, 2016

Related U.S. Application Data
(63) Continuation of application No. PCT/US2014/015429, filed on Feb. 7, 2014.

(51) Int. Cl. G06Q 30/02

(52) U.S. Cl. CPC G06Q 30/0275; G06Q 30/0277

(57) ABSTRACT

Discounting costs for conversions comprises an advertisement distribution system employing a server configured to receive a bid from an advertisement purchaser, the bid comprising an amount of funds the advertisement purchaser is willing to pay for an action of a user. The system identifies a first request associated with a first advertisement spot and determines an expected value for each of one or more prospective advertisements. The particular advertisement is selected for the advertisement spot based on having the highest expected value for the first request. The system facilitates the distributing the particular advertisement and may facilitate the distributing the advertisement in connection with a second request. If the system receives an indication that the action has been taken, the system discounts a cost associated with the action based on the lowest bid at which the particular advertisement could have still been selected in connection with the requests.

### TECHNICAL FIELD

The present disclosure relates generally to advertisement pricing, and more particularly to discounting costs for conversions to advertisement purchasers based on a level at which the advertisement purchasers would have received the same advertising distribution results associated with the conversions.

### BACKGROUND

In conventional systems, online and other advertisement distributors use second-price discounting to advertisement purchasers. An advertisement distribution system conducts auctions based on bids from advertisement purchaser systems for an advertisement spot or group of spots. The advertisement purchaser systems may bid on advertisement spots based on cost per view, cost per action, cost per conversion, cost per click, cost per impression, or in any suitable manner.

In a cost per action bid, the advertisement purchaser system pays the advertisement distribution system for each instance of an action by users. For example, if an advertisement purchaser system is a merchant, the merchant may pay the advertisement distribution system for each user that completes a survey, completes an online checkout from the merchant's e-commerce system, or any suitable action. In certain embodiments, the advertisement distribution system discounts the cost to an auction winner to a price based on the bid of the second-place bidder. The discounting serves to engender positive relationships between the advertisement distribution system and the bidders and to remove the incentive for bidders to bid less than their true willingness to pay.

When an advertisement distribution system utilizes multiple advertisement spots, attributing a user action or conversion to a particular one of the advertisement spots is difficult. A user may have encountered two or more advertisement spots before performing the conversion action.

Conventional systems do not allow the advertisement distribution system to discount the cost to the advertisement purchaser system based on the lowest price the advertisement purchasing system could have paid while achieving the same distribution results.

### SUMMARY

Techniques herein provide a computer-implemented method to discount costs for conversions to advertisement purchasers to a level at which the advertisement purchaser system would have received the same distribution results. An advertisement distribution system employs a server is configured to receive a bid from an advertisement purchaser, the bid comprising an amount of funds the advertisement purchaser is willing to pay for an action of a user associated with a particular advertisement. The system identifies a first request associated with a first advertisement spot and determines with respect to the first request, an expected value for each of one or more prospective advertisements, each expected value based on a bid associated with each prospective advertisement. The particular advertisement is selected for the advertisement spot based on the particular advertisement having the highest expected value for the first request. The system facilitates the distributing the particular advertisement in connection with the first request and may facilitate the distributing the advertisement in connection with a second request. If the system receives an indication that the action has been taken by the user, the system discounts a cost associated with the action based on the lowest bid at which the particular advertisement could have still been selected in connection with the first and the second requests.

In certain other example aspects described herein, a system and a computer program product are utilized to discount costs for conversions to advertisement purchasers based on a level at which the advertisement purchaser system would have received the same distribution results.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to discount costs for conversions to advertisement purchasers to a level at which the advertisement purchaser system would have received the same distribution results, in accordance with certain example embodiments.

FIG. 2 is a block flow diagram depicting a method to discount costs for conversions to advertisement purchasers to a level at which the advertisement purchaser system would have received the same distribution results, in accordance with certain example embodiments.

FIG. 3 is a block flow diagram depicting a method for an advertisement distribution system to select advertisements to use in advertisement spot and to place bids, in accordance with certain example embodiments.

FIG. 4 is a graph of the discounting of an example advertisement, in accordance with certain example embodiments.

FIG. 5 is a block diagram depicting a computing machine and a module, in accordance with certain example cmbodiments.

### DETAILED DESCRIPTION OF THE EXAMPLE EMBODIMENTS

### Overview

In one example embodiment, an advertisement purchaser system submits a bid for an advertisement to be placed in one or more advertisement spots. The bid comprises a maximum cost per action to be paid to the advertisement distribution system upon each performance of a qualifying action. In some cases, it is desirable for the advertisement distribution system to discount the cost to the advertisement purchaser system for the performance of qualifying actions. The advertisement distribution system identifies a request associated with an advertisement spot. In response to the request, the advertisement purchaser system identifies prospective advertisements and determines an expected value of each prospective advertisement with regard to the request. The advertisement distribution system compares the expected values of the prospective advertisements to select an advertisement for the advertisement spot. If the request associated with the advertisement spot requires a bid, the advertisement distribution system submits a bid to the advertisement presenter system based on the expected value of the selected advertisement. If the bid is won, the selected advertisement is provided for presentment to a user device. If the request does not require a bid, the selected advertisement is provided for presentment to a user device. The advertisement distribution system may select the same advertisement for one or more additional requests associated with advertisement spots based on the same advertisement winning the auctions associated with each request. After determining that a conversion occurred (e.g., a qualifying user action was taken), the advertisement distribution system determines the minimum amount that the advertisement purchaser system could have bid for the conversion of the proposed advertisement such that the advertisement distribution system would still have selected the proposed advertisement for each utilized advertisement spot associated with that conversion. The cost to the advertisement purchaser system for the conversion is discounted based on the determined minimum level.

In an example embodiment, an advertisement purchaser system bids a maximum amount that the advertisement purchaser system is willing to pay for a conversion. The conversion may be any action associated with the advertisement. For example, the advertisement purchaser system compensates the advertisement distribution system for each action of users that qualifies as a conversion. In an example, the action may be fulfilled by a purchase at a merchant location, a purchase at an online store, a physical appearance at a merchant location, a completion of a survey, or any other suitable action.

An advertisement spot becomes available to the advertisement distribution system, typically through an advertisement request associated with an advertisement presenter system. For example, an advertisement presenter system receives a request to present a webpage to a user. The advertisement presenter system has one or more advertisement spots available on the webpage. The advertisement presenter system may request bids for the advertisement spot or it may request an advertisement. In another example, the advertisement spot is an email advertisement to one or more users. In another example, the advertisement spot is a location-based alert or advertisement to a mobile device of a user. Any suitable advertisement may become available.

The advertisement distribution system determines the expected values of proposed advertisements for the available advertisement spot. For each proposed advertisement, the expected value may be based on the maximum amount that the advertisement purchaser system is willing to pay for a conversion and the expected conversion rate associated with the proposed advertisement. In an example, let's say the advertisement purchaser system bids a willingness to pay up to $1.00 for a conversion associated with a particular advertisement. The advertisement distribution system determines that the expected conversion rate is 10%. That is, for every ten users who receive the particular advertisement, one user is expected to perform a qualifying action. Therefore, the advertisement distribution system would determine that the expected value of providing the particular advertisement for the proposed advertisement spot would be worth $0.10 per impression (using the formula expected value/impression=income/conversion×conversion rate).

The expected conversion rate may be based on a database of similar advertisement spots and similar products being advertised. A machine learning algorithm may be utilized to calculate and update the expected conversion rate. The advertisement distribution system may use any suitable manner of determining the expected conversion rate. The expected conversion rate may further be based on knowledge of the purchasing history of the user. For example, if the user has consented to allow the advertisement distribution system to log or analyze search history of the user, the purchase history of the user, or other data of the behavior of the user, then the advertisement distribution system may be able to more accurately predict the probability of the user converting as a result of viewing an advertisement. The expected conversion rate may also be adjusted based on margins for uncertainty, profit or other factors.

In the example, the advertisement distribution system determines that, among the proposed advertisements, a particular advertisement from the advertisement purchaser system provides the highest expected value compared to the expected values from the other proposed advertisements from other advertisement purchasers.

If the advertisement presenter system is auctioning the advertisement spot to prospective advertisers, then the advertisement distribution system bids on the advertisement spot. The advertisement distribution system bids based on the expected value of the selected advertisement for the advertisement spot. In the example, if the expected value of the selected advertisement is $0.10 per impression, then the advertisement distribution system submits a bid to the advertisement presenter system based on this value. In certain cmbodiments, the bid may be the expected value, which in this example is $0.10. In certain embodiments, the advertisement distribution system includes a safety margin and/or a profit margin or other adjustments into the bid. In the example, the advertisement distribution system may bid $0.08 to the advertisement presenter system, instead of the expected value. The $0.02 below the calculated expected value may be a safety margin in the case that the expected conversion rate was calculated incorrectly. The $0.02 may additionally or alternatively be an attempt by the advertisement distribution system to extract a profit margin from the transactions. In certain embodiments, the additional margin may be incorporated when determining the expected conversion rate.

If the advertisement distribution system wins the bid, the proposed advertisement is transmitted to the advertisement presenter system for presentation to the user. The advertisement distribution system is charged an amount up to the amount bid for the impression.

In an example, the advertisement presenter system conducts the bid as a second price auction. That is, the advertisement presenter system receives bids and awards the advertisement spot the to highest bid. However, the advertisement presenter system invoices the winning bidder an amount equal to, or marginally higher than, the second highest bid. Thus, the amount paid by the advertisement distribution system may be lower than the amount bid for the advertisement spot.

In certain embodiments, the request for advertisement spot does not require a bid from the advertisement distribution system. When a bid is not required by the advertisement presenter system, the advertisement distribution system provides an advertisement selected after conducting an auction based on the expected values of prospective advertisements, as described above.

Advertisements that do not need to be purchased may still have an inherent cost to distribute. In one embodiment, advertisements do not need to be purchased when the advertisement presenter system is owned by the advertisement distribution system (i.e., there may not be a direct cost or expense charged to the advertisement distribution system for providing advertisements to the advertisement presenter system). The expected value comparison is still utilized. The opportunity cost is the forgone expected value of presenting a different advertisement, the forgone revenue of presenting a different advertisement from a different advertisement purchaser, or the forgone value of using the advertisement spot for a “house ad.” The house ad may be an advertisement for services provided by the advertising presenter system. In instances where an advertisement does not need to be purchased, the advertisement distribution system may determine if the expected value is greater than a minimum value. For example, if the expected value is below $0.05, then the advertisement distribution system may determine that the expected value is not great enough to provide the advertisement. The advertisement distribution system may instead provide a house advertisement or no advertisement at all.

In some embodiments, the proposed advertisement is transmitted to the advertisement presenter system, and the advertisement presenter system provides the advertisement to the user device for display to the user. In alternate embodiments, the advertisement is distributed directly to the user device, such as an emailed advertisement or a location-based alert.

In the example embodiment, one or more users perform the action required by the advertisement spot to be a conversion. For example, a user physically visits the merchant associated with the advertisement purchaser system, or a user purchases a product associated with the ad. The conversion is recorded in any suitable manner. For example, the advertisement purchaser system reports the conversion to the advertisement distribution system. In another example, the advertisement distribution system detects an online action of the user and records the conversion.

In certain embodiments, the advertisement distribution system is unable to determine which of the advertisement spots contributed to the conversion. The user may have viewed multiple advertisement spots. The user may have delayed the conversion for a period of time after viewing some of the contributing advertisement spots. For these and other reasons, the advertisement distribution system desires to discount the cost per action to the advertisement purchaser system to a level that encompasses all of the advertisement impressions that drove each conversion.

In certain embodiments, the advertisement distribution system may not be able to attribute certain advertisement impressions to any user or any qualifying action. In this case, the advertisement distribution system may limit the discounting process to only advertisement impressions associated with a user or qualifying action. Other discounting processes may be employed for the remaining (non-attributable) advertisements (for example, spreading the cost of such advertisements) or no discounting process may be used. In certain embodiments, the advertisement distribution system may include all advertisements in the discounting process even if all of the advertisements are not associated with a qualifying action or user.

The advertisement distribution system determines the utilized advertisement spots that are related to the conversion. The related advertisements may include any advertisements that were provided for display to the user preceding the conversion.

The advertisement distribution system determines the lowest amount that the advertisement purchaser system could have bid for actions and still had its advertisement selected for each of the utilized advertisement spots. In an example, the advertisement purchaser system had a proposed advertisement selected for three advertisement spots. That is, the proposed advertisement was determined to have the highest expected value, based on the cost per action bid and the expected conversion rate, of any of the proposed advertisements that were considered for each of the three advertisement spots.

In an example, three advertisements were considered for one of the advertisement spot and the expected value for each advertisement was $0.10, $0.05, and $0.01, respectively. The highest expected value is $0.10. To determine the amount that the advertisement purchaser system could have bid and still been selected for each advertisement, the advertisement distribution system determines the second highest expected value for the particular advertisement spot. In the example, the second highest expected value was $0.05.

To achieve an expected value of $0.05, the advertisement purchaser system could have bid a lower willingness to pay for an action. In the example, the advertisement purchaser system could have bid $0.50, with a 10% expected conversion rate, and achieved an expected value of $0.05. Thus, $0.50 is the lowest amount the advertisement purchaser system could have bid and still been selected for that particular advertisement spot. The procedure is repeated for each advertisement spot for which the advertisement associated with the conversion was chosen.

If the advertisement purchaser system could have bid $0.50 for one advertisement spot and $0.30 for each of the other two advertisement spots and still won all three advertisement spots, then $0.50 would be the lowest amount that the advertisement purchaser system could have bid for actions and still been selected for each of the utilized advertisement spots.

The advertisement distribution system discounts the cost to the advertisement purchaser system for each conversion to the determined amount. In the example, the advertisement distribution system charges the advertisement purchaser system $0.50 for the conversion. In certain embodiments, the advertisement distribution system charges a marginal amount greater than the determined minimum amount. The marginal amount may be $0.01, 1%, or any suitable amount greater than the minimal amount. In the example, the advertisement distribution system charges the advertisement purchaser system $0.51 per conversion.

For each recorded conversion, the advertisement purchaser system remits payment to the advertisement distribution system. The payment is in the amount of the discounted cost. In the example, the payment would be $0.50 per conversion. In certain embodiments, the amount remitted may include other charges or, in any suitable manner, differ from the discounted charge. For example, a profit margin may be added in before invoicing. In another example, an amount may be added to the invoice price to account for an un-attributable advertisement spend for each conversion that occurs. Any suitable adders or additional discounting may be included in the final cost to the advertisement purchasing system. Furthermore, the payment may be remitted by the advertisement purchasing system on any suitable schedule. For example, the advertisement purchasing system may be invoiced after a particular number of conversions are reached, after a period of time has elapsed, or on any other suitable schedule.

### Example System Architectures

Turning now to the drawings, in which like numerals represent like (but not necessarily identical) elements throughout the figures, example embodiments are described in detail.

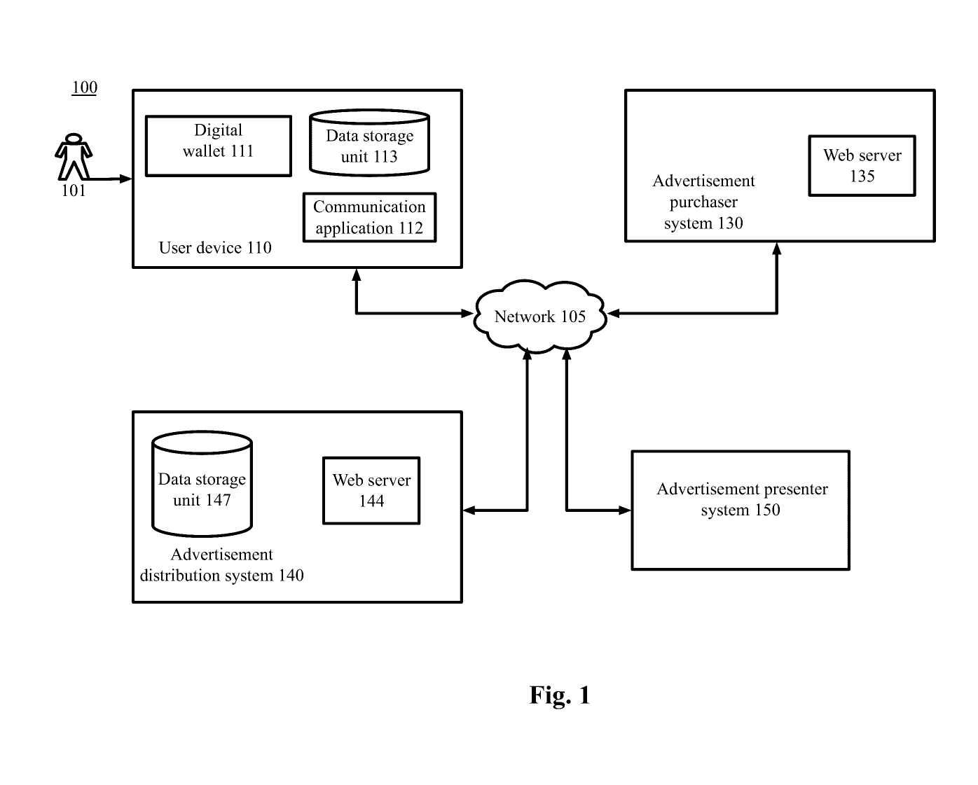

FIG. 1 is a block diagram depicting a system 100 to discount costs for conversions to advertisement purchasers to a level at which the advertisement purchaser system would have received the same distribution results, in accordance with certain example embodiments. In some embodiments, a user associated with a device must install an application and/or make a feature selection to obtain the benefits of the techniques described herein.

As depicted in FIG. 1, the system 100 includes network computing devices 110, 130, 140, and 150 that are configured to communicate with one another via one or more networks 105 or via any suitable communication technology.

Each network 105 includes a wired or wireless telecommunication means by which network devices (including devices 110, 130, 140, and 150) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 130, 140, and 150 may be similar networks to network 105 or an alternative communication technology.

Each network computing device 110, 130, 140, and 150 includes a computing device having a communication module capable of transmitting and receiving data over the network 105 or a similar network. For example, each network device 110, 130, 140, and 150 can include a server, desktop computer, laptop computer, tablet computer, a television with one or more processors embedded therein and/or coupled thereto, smart phone, handheld or wearable computer, personal digital assistant (“PDA”), or any other wired or wireless, processor-driven device. In the example embodiment depicted in FIG. 1, the network devices 110, 130, 140, and 150 are operated by end-users or consumers, advertisement purchaser system operators, advertisement distribution system operators, and advertisement presenter system operators, respectively.

The user 101 can use the communication application 112, which may be, for example, a web browser application or a stand-alone application, to view, download, upload, or otherwise access documents or web pages via a distributed network 105. The communication application 112 can interact with web servers or other computing devices connected to the network 105, including the web server 144 of the advertisement distribution system 140.

The user network device 110 may include a digital wallet application module 111. The digital wallet application module 111 may encompass any application, hardware, software, or process the user computing device 110 may employ to assist the user 101 in completing a purchase. The digital wallet application module 111 can interact with the communication application 112 or can be embodied as a companion application of the communication application 112. As a companion application, the digital wallet application module 111 executes within the communication application 112. That is, the digital wallet application module 111 may be an application program embedded in the communication application 112. In certain embodiments a digital wallet of the user 101 may reside in a cloud computing environment, on a merchant server, or in any other environment.

The user computing device 110 also includes a data storage unit 113 accessible by the digital wallet application module 111 and the communication application 112. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In certain embodiments, the data storage unit 113 may reside in a cloud based computing system.

The advertisement distribution system 140 may include a data storage unit 147 accessible by the web server 144. The example data storage unit 147 can include one or more tangible computer-readable storage devices, or the data storage unit may be a separate system, such as, a different physical or virtual machine, or a cloud-based storage service. The advertisement distribution system 140 is operable to receive bids from advertisement purchaser systems 130, select advertisements to appear in advertisement spots, record conversions of advertisements, invoice advertisement purchaser systems 130, remit payments to advertisement presenter systems 150, and perform other suitable functions.

The user 101 may receive advertisements associated with the advertisement purchaser system 130. In an example embodiment, the advertisement purchaser system 130 provided an advertisement to the advertisement distribution system 140. The advertisement is distributed to the advertisement presenter system 150, which displays the advertisement to one or more user computing devices 110. The advertisement purchaser system 130 may upload an advertisement to the advertisement distribution system 140 for distribution, select an advertisement format from the advertisement distribution system 140, or in any suitable manner select an advertisement for distribution. The web server 135 may be used to store advertisements, create advertisements, communicate with the advertisement distribution system 140, or perform any suitable functions.

The advertisement presenter system 150 represents the system that provides an advertisement associated with the advertisement purchaser system 130 to the user computing device 110. For example, the advertisement presenter system 150 may be a website that displays the advertisement when the user computing device 110 accesses the website. In another example, the advertisement presenter system 150 may be a billboard, online publication, email system, mobile application, location-based application, map application, or any suitable advertisement presenter.

It will be appreciated that the network connections shown are examples and other means of establishing a communications link between the computers and devices can be used. Moreover, those having ordinary skill in the art having the benefit of the present disclosure will appreciate that the advertisement purchaser system 130, advertisement distribution system 140, advertisement presenter system 150, and the user computing device 110 illustrated in FIG. 1 can have any of several other suitable computer system configurations. For example, a user computing device 110 embodied as a mobile phone or handheld computer may not include all the components described above.

### Example Processes

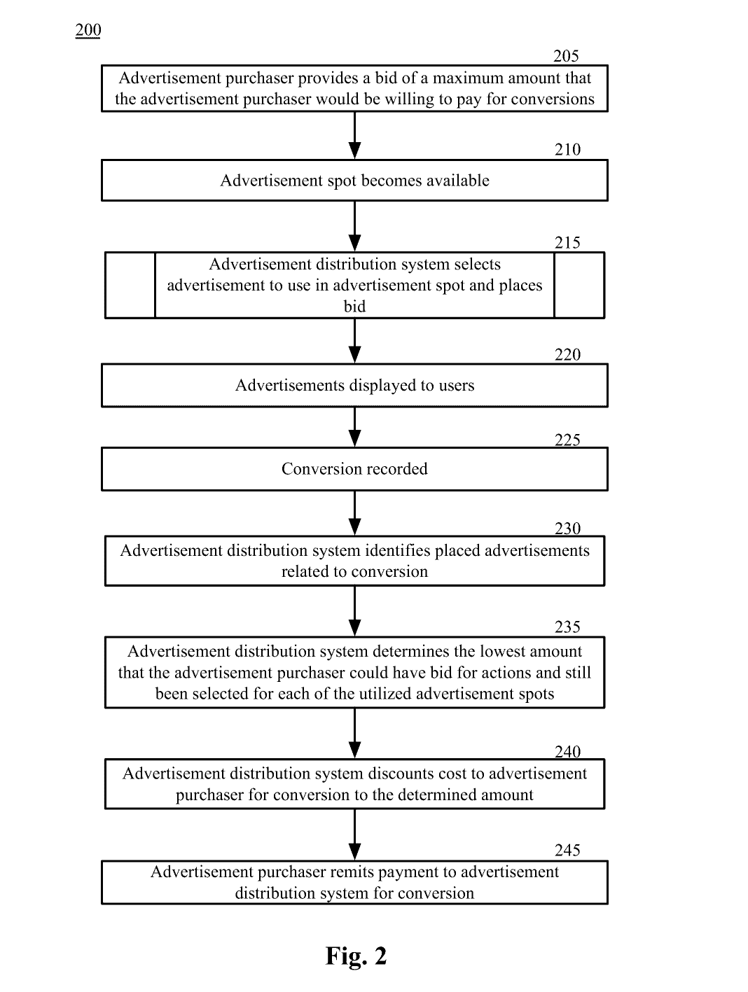

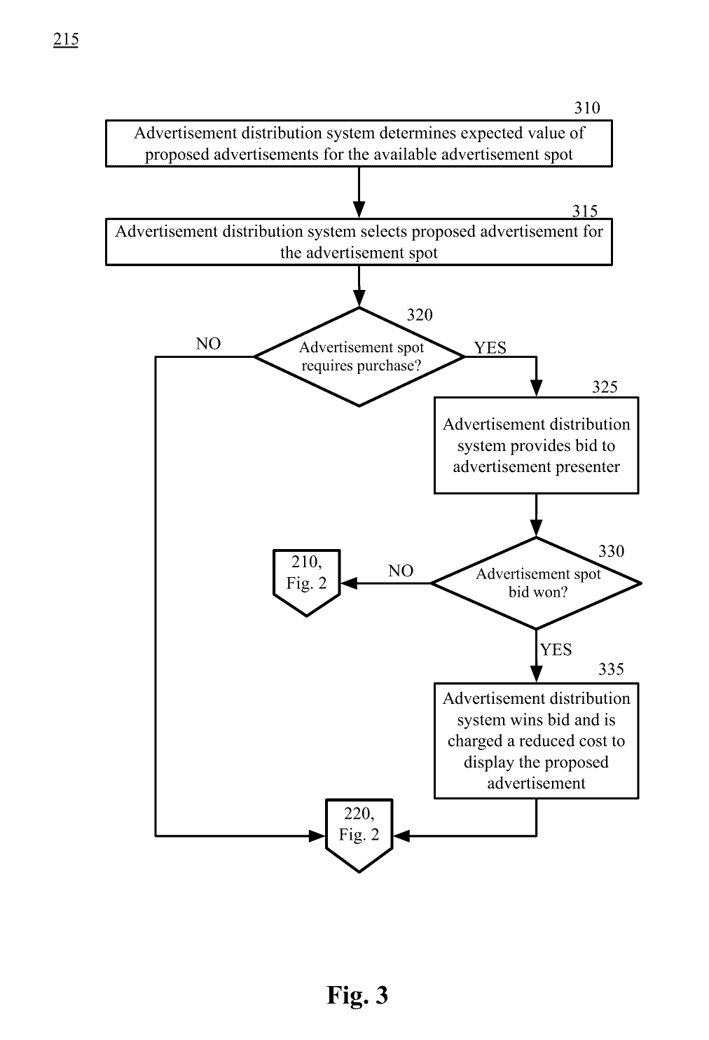

The example methods illustrated in FIG. 2-3 are described hereinafter with respect to the components of the example operating environment 100. The example methods of FIG. 2-3 may also be performed with other systems and in other environments.

FIG. 2 is a block flow diagram depicting a method 200 to discount costs for conversions to advertisement purchasers to a level at which the advertisement purchaser system 130 would have received the same distribution results, in accordance with certain example embodiments.

With reference to FIGS. 1 and 2, in block 205, an advertisement purchaser system 130 bids a maximum amount that the advertisement purchaser system 130 is willing to pay for a conversion. The conversion may be any action required by the conditions of the advertisement. For example, the advertisement purchaser system 130 compensates the advertisement distribution system 140 for each action of users 101 that qualifies as a conversion. In an example, the action may be fulfilled by a purchase at a merchant location, a purchase at an online store, a physical appearance at a merchant location, a completion of a survey, or any suitable action.

In block 210, an advertisement spot becomes available to the advertisement distribution system 140. For example, an advertisement presenter system 150 receives a request to present a webpage to a user 101. The advertisement presenter system 150 has one or more advertisement spots available on the webpage. The advertisement presenter system 150 provides a request for one or more advertisement distribution systems 140 to provide a bid for the advertisement spot. If a bid is not required, then the advertisement presenter system 150 provides a request for the advertisement for the advertisement spot. The advertisement presenter system 150 receives bids for the advertisement spot. In another example, the advertisement spot is an email advertisement to one or more users 101. In another example, the advertisement spot is a location-based alert or advertisement to a user computing device 110. Any suitable advertisement spot may become available.

In block 215, the advertisement distribution system 140 selects advertisements to use in the advertisement spot and places bids. The details of block 215 are described in greater detail with respect to method 215 of FIG. 3.

FIG. 3 is a block flow diagram depicting a method 215 for an advertisement distribution system 140 to selects advertisements to use in the advertisement spot and place a bid, in accordance with certain example embodiments.

In block 310, the advertisement distribution system 140 determines the expected value of proposed advertisements for the available advertisement spot associated with the request from the advertisement presenter system 150 or any available advertisement spot. The expected value may be based on the maximum amount that the advertisement purchaser system 130 is willing to pay for a conversion and the expected conversion rate.

In an example, the advertisement purchaser system 130 bid a willingness to pay $1.00 for a conversion. The advertisement distribution system 130 determines that the expected conversion rate is 10%. That is, for every ten users that receive the advertisement, one user is expected to perform the required action. Therefore, the advertisement distribution system would determine that the expected value of the proposed advertisement in the proposed advertisement spot would be worth $0.10 per impression. (expected value/impression=income/conversion×conversion rate.)

The expected conversion rate may be based on a database of similar advertisement spots and similar products being advertised. A machine learning algorithm may be utilized to calculate and update the expected conversion rate. The advertisement distribution system may use any suitable manner of determining the expected conversion rate. The expected conversion rate may further be based on knowledge of the online history of the user 101. For example, if the user has selected an option to allow the advertisement distribution system to log or analyze search history of the user 101, the purchase history of the user 101, or other data of the behavior of the user 101, then the advertisement distribution system may be able to more accurately predict the odds of the user 101 converting the advertisement. The expected conversion rate may be discounted by a percentage or an amount to accommodate a safety margin and/or a profit margin or other adjustment factor. In an example, the expected conversion rate may be discounted from 10% to 8%. Any suitable data may be employed to assist in the prediction of the expected conversion rate.

In block 315, the advertisement distribution system 140 selects the proposed advertisement from the advertisement purchaser system 130 for the advertisement spot. In the example, the proposed advertisement was determined to have a value of $0.10 per impression for the particular advertisement spot. If other potential advertisements for the particular advertisement spot were expected to have a value of $0.05 and $0.01 per impression, then the proposed advertisement from the advertisement purchaser system 130 would have the highest expected value.

In block 320, the advertisement distribution system 140 determines if the advertisement spot requires purchasing. Many advertisement spots must be purchased from the advertisement presenter system 150 or any system that sells the advertisement spots. Other advertisement spots do no require a purchase. For example, an emailed advertisement that is generated by the advertisement distribution system 140 does not need to be purchased. Advertisements that do not need to be purchased may still have an inherent cost to distribute. In one embodiment, advertisements do not need to be purchased when the advertisement presenter system 150 is owned by the advertisement distribution system 140. The expected value comparison is still utilized. The opportunity cost is the forgone expected value of presenting a different advertisement, the forgone revenue of presenting a different advertisement from a different advertisement purchaser, or the forgone value of using the advertisement spot for a “house ad.” The house ad may be an advertisement for services provided by the advertising presenter system. In instances where an advertisement does not need to be purchased, the advertisement distribution system 140 may determine if the expected value is greater than a minimum value. For example, if the expected value is below $0.05, then the advertisement distribution system 140 may determine that the expected value is not great enough to provide the advertisement. The advertisement distribution system 140 may instead provide a house advertisement or no advertisement at all.

If the advertisement spot does not require a purchase, then the method 215 proceeds to block 220 in FIG. 2. If the advertisement spot does require a purchase, then the method 215 proceeds to block 325.

In block 325, if the advertisement presenter system 150 is auctioning the advertisement spot to prospective advertisers, then the advertisement distribution system 140 bids on the advertisement spot. The advertisement distribution system 140 bids the expected value of the advertisement for the advertisement spot. In the example, if the expected value of the proposed advertisement is $0.10 per impression, then the advertisement distribution system bids $0.10 to the advertisement presenter system. In certain embodiments, the advertisement distribution system 140 includes a safety margin and/or a profit margin into the bid. In the example, the advertisement distribution system 140 may bid $0.08 to the advertisement presenter system. The $0.02 below the calculated expected value may be a safety margin in the case that the expected conversion rate was calculated incorrectly. The $0.02 may additionally or alternatively be an attempt by the advertisement distribution system to extract a profit margin from the transactions. In certain embodiments, the additional margin may be incorporated when determining the expected conversion rate.

In block 330, if the advertisement distribution system 140 does not win the auction, then the method 215 proceeds to block 210 with respect to FIG. 2. The proposed advertisement may remain in the list of proposed advertisements and may be reevaluated when the next advertisement spot becomes available.

If the advertisement distribution system 140 determines that the advertisement spot has been won in the auction, then the method 215 proceeds to block 335.

If the advertisement distribution system 140 wins the bid, the proposed advertisement is transmitted to the advertisement presenter system 150 for presentation to the user. The advertisement distribution system 140 is charged an amount up to the amount bid for the impression.

In an example, the advertisement presenter system 150 conducts the bid as a second price auction. That is, the advertisement presenter system 150 receives bids and awards the advertisement spot the to highest bid. However, the advertisement presenter system 150 invoices the winning bidder an amount equal to, or marginally higher than, the second highest bid. Thus, the amount paid by the advertisement distribution system 140 may be lower than the amount bid for the advertisement spot.

Returning to block 220 of FIG. 2, the advertisements are displayed to users 101. The advertisement spot is utilized for the advertisement associated with the advertisement purchaser system 130. The advertisement is distributed to users 101 in a manner proscribed by the seller of the advertisement spots, by the advertisement distribution system 140, or by any manager or owner of the advertisement spots. In an example, the advertisement is displayed on a webpage of the advertisement presenter system 150.

In the example embodiment, one or more users 101 perform the action required by the advertisement spot to be a conversion. For example, a user 101 physically visits a merchant associated with the advertisement purchaser system 130, a user 101 purchases a product associated with the ad, a user 101 clicks a link in an advertisement, a user 101 downloads an offer, a user 101 completes a survey, or performs any suitable action.

In block 225, the conversion is recorded in any suitable manner. For example, the advertisement purchaser system 130 reports the conversion to the advertisement distribution system 140. In another example, the advertisement distribution system 140 detects on online action of the user and records the conversion.

In block 230, the advertisement distribution system 140 identifies one or more placed advertisements related to the conversion. In certain embodiments, the advertisement distribution system 140 is unable to determine which of the advertisement spots contributed to the conversion. The user 101 may have viewed multiple advertisement spots. The user 101 may have delayed the conversion for a period of time after viewing the contributing advertisement spot. For these and other reasons, the advertisement distribution system 140 desires to discount the advertisement spots to the advertisement purchaser system 130 to a level that encompasses all of the advertisement spot purchases.

In certain embodiments, the advertisement distribution system 140 may not have a clear indication of every advertisement spot viewed by the user 101. The advertisement distribution system 140 may limit the discounting process to only advertisements for which there is confirmation that the user 101 viewed the advertisement. Other discounting processes may be employed for the remaining advertisements or no discounting process may be used. In certain embodiments, the advertisement distribution system 140 may include all advertisements in the discounting process even if confirmation does not exist that all of the advertisements were viewed by the user 101.

In block 235, the advertisement distribution system 140 determines the lowest amount that the advertisement purchaser system 130 could have bid for actions and still been selected for each of the utilized advertisement spots. In an example, the advertisement purchaser system 130 had a proposed advertisement selected for three advertisement spots. That is, the proposed advertisement was determined to have the highest expected value based on the cost per action bid and the expected conversion rate of any of the proposed advertisements that were considered for each of the three advertisement spots.

In an example, three advertisements were considered for one of the advertisement spots and the expected value each advertisement was $0.10, $0.05, and $0.01, respectively. The highest expected value is $0.10. To determine the amount that the advertisement purchaser system 130 could have bid and still been selected for each advertisement, the advertisement distribution system 140 determines the second highest expected value for the particular advertisement spot. In the example, the second highest expected value was $0.05.

To achieve an expected value of $0.05, the advertisement purchaser system 130 could have bid a lower willingness to pay for an action. In the example, the advertisement purchaser system 130 could have bid $0.50, with a 10% expected conversion rate, and achieved an expected value of $0.05. Thus, $0.50 is the lowest cost per action the advertisement purchaser system could have bid and still been selected for the particular advertisement spot. The procedure is repeated for each advertisement spot for which the advertisement associated with the particular conversion was chosen.

If the advertisement purchaser system could have bid $0.50 for one advertisement spot and $0.30 for each of the other two advertisement spots and still won all three advertisement spots, then $0.50 would be the lowest amount that the advertisement purchaser system could have bid for actions and still been selected for each of the utilized advertisement spots.

In block 240, the advertisement distribution system 140 discounts the cost to the advertisement purchaser for conversion to the determined amount. In the example, the advertisement distribution system 140 charges the advertisement purchaser system 130 $0.50 for the conversion. In certain embodiments, the advertisement distribution system 140 charges a marginal amount greater than the determined minimum amount. The marginal amount may be $0.01, 1%, or any suitable amount greater than the minimal amount. In the example, the advertisement distribution system charges the advertisement purchaser system $0.51 per conversion.

In certain embodiments, some of the advertisements spots are un-attributable to a specific conversion. The advertisement distribution system 140 may desire a manner of allocating the costs of the un-attributable advertisement spots. In one embodiment, the advertisement distribution system 140 does not discount the cost for a conversion for early redemptions. After a certain level of conversions have occurred, a reasonable cost per conversion may be calculated for un-attributable advertisement spots. The advertisement distribution system 140 grosses up the discounted cost for a conversion for all subsequent conversions by that average “carrying cost” of un-attributable advertisement spots.

In an alternate embodiment, the advertisement distribution system 140 may use the running average of un-attributable advertisement spot spending per conversion in the calculation for the expected value for each future proposed advertisement. The advertisement distribution system 140 may adjust the bids to provide a margin to fund the un-attributable advertisement spot spending. The margin may be utilized in a similar manner as the profit or safety margins.

In an alternate embodiment, the advertisement distribution system 140 may increase or decrease the un-attributable advertisement spot spending to achieve a desired cost per conversion, which can be covered by the safety or profit margin incorporated during the bidding process.

In certain embodiments, the un-attributable advertisement spot spending does not affect the bidding processes as described herein.

In block 245, for each recorded conversion, the advertisement purchaser system 130 remits payment to the advertisement distribution system 140 system. The payment is in the amount of the discounted cost per action. In the example, the payment would be $0.50 per conversion.

In certain embodiments, the amount remitted may include other charges or, in any suitable manner, differ from the discounted charge. For example, a profit margin may be added in before invoicing. In another example, an amount may be added to the invoice price to account for an un-attributable advertisement spend for each conversion that occurs. Any suitable adders or additional discounting may be included in the final cost to the advertisement purchasing system 130. Furthermore, the payment may be remitted by the advertisement purchasing system 130 on any suitable schedule. For example, the advertisement purchasing system may be invoiced after a particular number of conversions are reached, after a period of time has elapsed, or on any other suitable schedule.

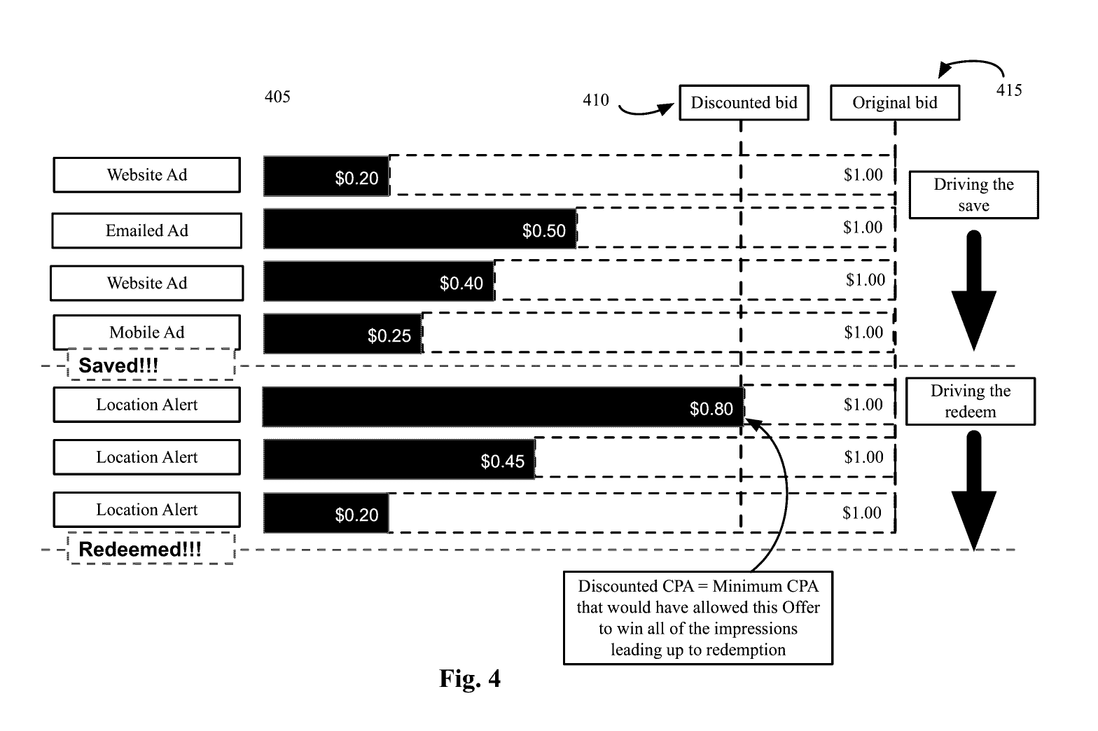

FIG. 4 is a graph of the discounting of an example advertisement. The graph illustrates the minimum cost per action (“CPA”) bid 405 for a variety of advertisements that the advertisement purchaser system 130 could have bid and still won the auction for the advertisement spot. The minimum CPA bids 405 are calculated in the manner described herein. In the example, the first website advertisement had minimum CPA bid 405 of $0.20. The advertisement purchaser system 130 offered a willingness to pay $1.00 for each action. In the example, the required action is a redeeming of the offer at the merchant location.

The greatest minimum CPA bid for the utilized advertisement spots was $0.80 for the first location alert. Thus, the CPA invoiced to the advertisement purchaser system 130 is reduced to $0.80.

Detailed examples are provided below illustrating the manner in which auction pricing might proceed.

The first example illustrates a single alert on a paid channel. In the example a user 101 views an advertisement on a website for an offer at a physical retail store, which the user 101 saves and then redeems.

TABLE 1

| | | | Advertisement | | | | |
|---|---|---|---|---|---|---|---|
| | Predicted | | Distribution | Competing | Competing | | Merchant |
| | Delta | | System | Offer | Bidder | Actual | Minimum |
| | Conversion | Merchant | Willingness | Willingness | Willingness | Impression | Required |
| Auction | Rate | CPA Bid | to Pay | to Pay | to Pay | Cost | Bid |
| Website | +10% | $1.00 | $0.10 | $0.045 | $0.03 | $0.03 | $0.45 |
| advertisement | | | | | | | |

| | |
|---|---|
| Merchant CPA Bid | $1.00 |
| CPA Paid | $0.45 |
| Merchant Surplus | $0.55 |
| Advertisement Distribution | $0.42 |
| System Profit | |

In the example, the predicted delta conversion rate (“PDCR”) represents the advertisement distribution system's 140 best estimate of the how much the likelihood of redemption of a particular offer would change for a particular user 101 if the user 101 received an impression on a particular channel at a particular time. A safety/profit margin may be included in the estimate. The estimate can change based on many factors, including the history of interactions that the user 101 has had with that offer. The merchant cost per action (“CPA”) bid indicates the amount that the merchant bid as the maximum CPA they were willing to pay. The advertisement distribution system 140 willingness to pay (“ADWtP”) indicates the maximum amount the advertisement distribution system 140 is willing to pay for a particular impression to an advertisement presenter system 150. The ADWtP is the expected value to the advertisement distribution system 140 for showing a particular offer to a particular user on a particular channel at a particular time. ADWtP=PDCR*merchant CPA bid.

The competing offer willingness to pay (“COWtP”) indicates the highest amount that the advertisement distribution system 140 is willing to pay for this impression for any other offer from any advertisement purchaser system associated with the advertisement distribution system based on the expected value of the advertisement. The competing bidder willingness to pay (“CBWtP”)—for monetized channels, the CBWtP is the amount that any other bidder is willing to pay for the impression. The actual impression cost indicates the amount paid to the channel for the impression. The amount may be lower than the COWtP if the bid uses a second price bidding auction or a similar discounting structure.

Merchant minimum required bid (“MRB”) indicates the minimum CPA bid the merchant could have made and still kept its place in the auction results. The MRB equals the highest competing bid, marked up to account for the predicted delta in conversion Rate. MRB=Max(COWtP, CBWtP)*(1/PDCR).

CPA paid indicates the price that the merchant actually paid for the redemption. The merchant surplus indicates the “free value” that the merchant received by virtue of the redemption costing less than the merchant had bid. Merchant Surplus=Merchant CPA Bid−CPA Paid.

The advertisement distribution system 140 profit indicates the profit that the advertisement distribution system 140 captures for a single offer for a single consumer by virtue of being able to buy impressions for less than money than the ultimate offer redemption generates. The advertisement distribution system 140 profit can be negative when the advertisement distribution system 140 buys impressions that don't lead to a redemption, or when the advertisement distribution system 140 spends more money buying impressions than it ultimately earns on the final redemption. Advertisement distribution system 140 profit=CPA Paid−Sum of the cost of all impressions purchased for that offer and that user. (Note the CPA Paid is $0 until the redemption actually occurs, so initially the advertisement distribution system 140 will always have a negative profit).

The second example illustrates a single alert on an unpaid channel. In the example, a user 101 views a location-based alert on a mobile device for an offer at a physical retail store, which she saves and then redeems (without any further alerts).

TABLE 2

| | | | Advertisement | | | | |
|---|---|---|---|---|---|---|---|
| | Predicted | | distribution | Competing | Competing | | Merchant |
| | Delta | | system | Offer | Bidder | Actual | Minimum |
| | Conversion | Merchant | willingness | Willingness | Willingness | Impression | Required |
| Auction | Rate | CPA Bid | to pay | to Pay | to Pay | Cost | Bid |
| Mobile Location | +10% | $1.00 | $0.10 | $0.041 | — | — | $0.41 |
| Based Alert | | | | | | | |

| | |
|---|---|
| Merchant CPA Bid | $1.00 |
| CPA Paid | $0.41 |
| Merchant Surplus | $0.59 |
| Advertisement Distribution | $0.41 |
| System Profit | |

The third example illustrates two alerts on different channels. The user 101 receives an offer via email, which the user 101 opens, but doesn't save. The user 101 then views an advertisement for the same offer on an advertisement on a website, which she saves and then redeems (without any further alerts).

TABLE 3

| | | | Advertisement | | | | |
|---|---|---|---|---|---|---|---|
| | Predicted | | Distribution | Competing | Competing | | Merchant |
| | Delta | | System | Offer | Bidder | Actual | Minimum |
| | Conversion | Merchant | Willingness | Willingness | Willingness | Impression | Required |
| Auction | Rate | CPA Bid | to Pay | to Pay | to Pay | Cost | Bid |
| Emailed offer | +20% | $1.00 | $0.20 | $0.11 | — | — | $0.55 |
| Website | +10% | $1.00 | $0.10 | $0.045 | $0.02 | $0.02 | $0.45 |
| advertisement | | | | | | | |

| | |
|---|---|
| Merchant CPA Bid | $1.00 |
| CPA Paid | $0.55 |
| Merchant Surplus | $0.45 |
| Advertisement Distribution | $0.53 |
| System Profit | |

The fourth example illustrates a complex example. The user 101 views an advertisement on a website featuring an offer at a physical retail store. The user 101 does not click the advertisement. The user 101 receives an offer via email featuring the same offer. The user 101 does not click the advertisement. The user 101 goes to a mall and receives a location based alert for that offer at the store location in the mall. The user 101 does not click the advertisement.

The user 101 goes to the mall on a different day, and receives another location based alert advertisement for the same offer. The user 101 saves the advertisement, but does not redeem the advertisement. The user 101 goes to the mall and receives a nearby saved offer notification. The user 101 does not redeem the advertisement. The user 101 goes to the mall again and receives another nearby saved-offer notification. The user 101 does not redeem the advertisement. The user 101 then spends a couple of hours having lunch and doing other shopping.

Finally, the user 101 stops at a different location of the same retailer on her way home and redeems the offer.

TABLE 4

| | | | Advertisement | | | | |
|---|---|---|---|---|---|---|---|
| | Predicted | | Distribution | Competing | Competing | | Merchant |
| | Delta | | System | Offer | Bidder | Actual | Minimum |
| | Conversion | Merchant | Willingness | Willingness | Willingness | Impression | Required |
| Auction | Rate | CPA Bid | to Pay | to Pay | to Pay | Cost | Bid |
| Website | +10% | $1.00 | $0.10 | $0.01 | $0.02 | $0.02 | $0.20 |
| advertisement | | | | | | | |
| Emailed offer | +20% | $1.00 | $0.20 | $0.10 | — | — | $0.50 |
| Location based | +10% | $1.00 | $0.10 | $0.04 | — | — | $0.40 |
| advertisement | | | | | | | |
| Location based | +4% | $1.00 | $0.04 | $0.01 | — | — | $0.25 |
| advertisement | | | | | | | |
| Location based | +15% | $1.00 | $0.15 | $0.05 | — | — | $0.3333 |
| alert | | | | | | | |
| Location based | +7% | $1.00 | $0.07 | $0.01 | — | — | $0.1429 |
| alert | | | | | | | |

| | |
|---|---|
| Merchant CPA Bid | $1.00 |
| CPA Paid | $.50 |
| Merchant Surplus | $.50 |
| Advertisement Distribution | $.48 |
| System Profit | |

### Example Systems

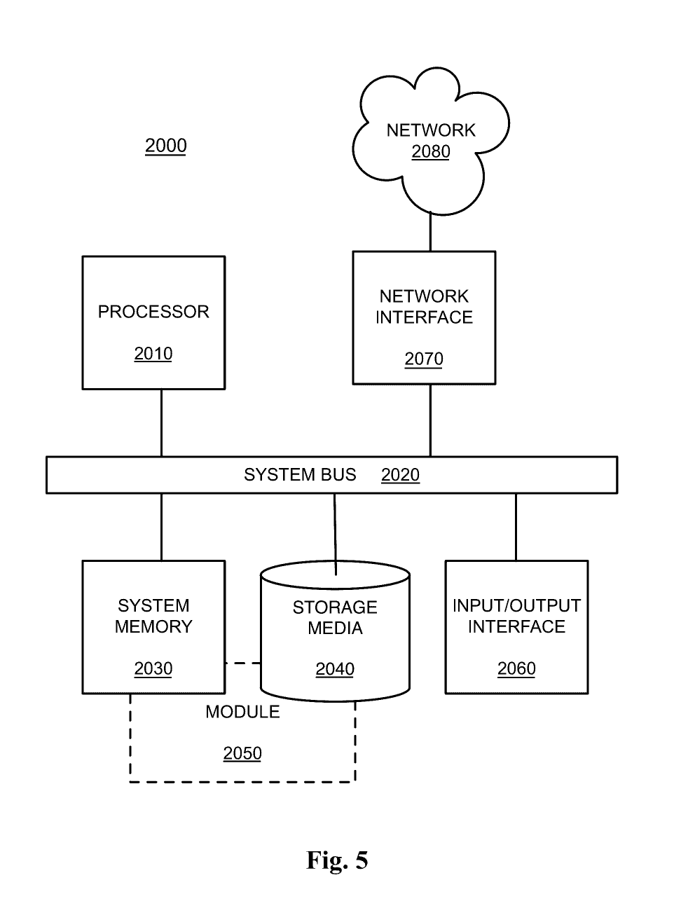

FIG. 5 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The 1/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to discount costs to advertisement purchasers, comprising:
receiving, using one or more computing devices, a bid from an advertisement purchaser, the bid comprising an amount of funds the advertisement purchaser is willing to pay for an action of a user associated with a particular advertisement;
identifying, using the one or more computing devices, a first request associated with a first advertisement spot;
determining, using the one or more computing devices, with respect to the first request, an expected value for each of one or more prospective advertisements, each expected value based on a bid associated with each prospective advertisement;
selecting, using the one or more computing devices, the particular advertisement based on the particular advertisement having the highest expected value for the first request;
facilitating the distributing, using the one or more computing devices, the particular advertisement in connection with the first request;
identifying, using the one or more computing devices, a second request associated with a second advertisement spot;
determining, using the one or more computing devices, with respect to the second request, an expected value for each of one or more prospective advertisements, each expected value based on a bid associated with each prospective advertisement;
selecting, using the one or more computing devices, the particular advertisement based on the particular advertisement having the highest expected value for the second request;
facilitating the distributing, using the one or more computing devices, the particular advertisement in connection with the second request;
receiving, using the one or more computing devices, an indication that the action has been taken by the user; and
discounting, to the advertisement purchaser, using the one or more computing devices, a cost associated with the action based on the lowest bid at which the particular advertisement could have still been selected in connection with the first and the second requests.

2. The computer-implemented method of claim 1, wherein the cost is discounted to a configured amount greater than the lowest cost at which the particular advertisement associated with the advertisement purchaser could have been bid and still have been selected in connection with the first and the second requests.

3. The computer-implemented method of claim 1, further comprising:
bidding, using the one or more computing devices, in an auction for each of the first and second advertisement spots in connection with the first and second requests; and
receiving, using the one or more computing devices, a notification that the bid for each of the first and second advertisement spots was successful.

4. The computer-implemented method of claim 3, wherein the amount bid for each of the first and second requests is based on the respective expected value of the particular advertisement associated with the advertisement purchaser for each of the first and second requests.

5. The computer-implemented method of claim 1, wherein the first and second requests do not require bids in response to the requests.

6. The computer-implemented method of claim 1, wherein the advertising spots comprise an emailed offer, an online ad, or a location-based alert.

7. The computer-implemented method of claim 1, wherein the action of the user comprises a purchase, an appearance at a physical location, completion of a survey, or a visit to a website.

8. The computer-implemented method of claim 1, wherein the expected value for the particular advertisement is based on the bid from the advertisement purchaser and an expected conversion rate.

9. The computer-implemented method of claim 1, wherein the expected value for each of the one or more prospective advertisements is determined with a machine learning algorithm.

10. The computer-implemented method of claim 1, wherein three or more requests associated with advertisement spots are identified, and the particular advertisement is selected in connection with each of the three or more requests, and
wherein discounting a cost comprises discounting to the advertisement purchaser, using the one or more computing devices, the cost associated with the action based on a level equal to a lowest cost at which the particular advertisement associated with the advertisement purchaser could have been bid and still have been selected in connection with the three or more requests.

11. A computer program product, comprising:
a non-transitory computer-readable storage device having computer-executable program instructions embodied thereon that when executed by a computer cause the computer to discount costs for conversions to advertisement purchasers, the computer-executable program instructions comprising:
computer-executable program instructions to receive a bid from an advertisement purchaser, the bid comprising an amount of funds the advertisement purchaser is willing to pay for an action of a user associated with a particular an advertisement;
computer-executable program instructions to identify a first request associated with a first advertisement spot and a second request associated with a first advertisement spot;
computer-executable program instructions to determine with respect to the first request and the second request, an expected value for each of one or more prospective advertisements, each expected value based on a bid associated with each prospective advertisement;
computer-executable program instructions to select the particular advertisement based on the particular advertisement having the highest expected value for the first request and the second request;
computer-executable program instructions to facilitate the distributing the particular advertisement in connection with the first request and the second request;
computer-executable program instructions to receive an indication that the action has been taken by the user; and
computer-executable program instructions to discount, to the advertisement purchaser, a cost associated with the action based on the lowest bid at which the particular advertisement could have still been selected in connection with the first and the second requests.

12. The computer program product of claim 11, wherein the cost is discounted to a configured amount greater than the lowest cost at which the particular advertisement associated with the advertisement purchaser could have been bid and still have been selected in connection with the first and the second requests.

13. The computer program product of claim 11, further comprising computer-executable program instructions to:
bid in an auction for each of the first and second advertisement spots in connection with the first and second requests; and
receive a notification that the bid for each of the first and second advertisement spots was successful.

14. The computer program product of claim 11, wherein the first and second requests do not require bids in response to the requests.

15. The computer program product of claim 11, wherein the advertising spots comprise an emailed offer, an online ad, or a location based alert.

16. The computer program product of claim 11, wherein the action of the user comprises a purchase, an appearance at a physical location, completion of a survey, or a visit to a website.

17. A system to select payment accounts to discount costs for conversions to advertisement purchasers, the system comprising:
a storage resource; and
a processor communicatively coupled to the storage resource, wherein the processor executes application code instructions that are stored in the storage resource and that cause the system to:
receive a bid from an advertisement purchaser, the bid comprising an amount of funds the advertisement purchaser is willing to pay for an action of a user associated with a particular advertisement;
identify a first request associated with a first advertisement spot and a second request associated with a second advertisement spot;
determine, with respect to the first request and the second request, an expected value for each of one or more prospective advertisements, each expected value based on a bid associated with each prospective advertisement;
select the particular advertisement based on the particular advertisement having the highest expected value for the first request and the second request;
facilitate the distributing the particular advertisement in connection with the first request and the second request;
receive an indication that the action has been taken by the user; and
discount, to the advertisement purchaser, a cost associated with the action based on the lowest bid at which the particular advertisement could have still been selected in connection with the first and the second requests.

18. The system of claim 17, wherein the expected value for the particular advertisement is based on the bid from the advertisement purchaser and an expected conversion rate.

19. The system of claim 17, wherein the expected value for each of the one or more prospective advertisements is determined with a machine learning algorithm.

20. The system of claim 17, further comprising application code instructions that are stored in the storage resource and that cause the system to:
bid in an auction for each of the first and second advertisement spots in connection with the first and second requests; and
receive a notification that the bid for each of the first and second advertisement spots was successful.
